(19) United States
(12) Patent Application Publication
(10) Pub. No.: US 2004/0238499 A1
(43) Pub. Date: Dec. 2, 2004

(54) Electrically driven dot welding pliers comprising an electrical indexing and de-indexing device

(76) Inventor: Michel Beffrieu, Gournay (FR)

Correspondence Address: YOUNG & THOMPSON, 745 SOUTH 23RD STREET, 2ND FLOOR, ARLINGTON, VA, 22202, US

(21) Appl. No.: 10/488,880

(22) PCT Filed: Sep. 10, 2002
(86) PCT No.: PCT/FR02/03076

(30) Foreign Application Priority Data
Sep. 10, 2001 (FR) 01/11696

(51) Int. Cl. B23K 11/10

(52) U.S. Cl. 219/90

(57) ABSTRACT

The invention is characterized in that the indexing and de-indexing device comprises an electric step motor (19) controlling, via a screw-nut type mechanical transmission (18), a sliding indexing pin (15) moving between an abutting position against the fixed indexed arm (3) and a position spaced apart from the fixed indexed arm (3), said electric motor being controlled by a management electronic module (20) designed to receive a control signal (22) and, in response to the reception of said signal, to power the motor (19) and provide controlled displacement of the indexing pin (15). The invention is applicable to electrically-driven welding pliers.

The present invention concerns electrically driven dot welding pliers comprising a device enabling the indexing and the de-indexing, that is the locking and unlocking, of the movement of the pliers, for example the rotation in the case of X-shaped pliers or the translation in the case of J-shaped pliers, in relation to their support, for example a robot arm on which said pliers are mounted.

A welding cycle is divided into three phases: squeezing, welding and disengagement. During the welding phase, the welding pliers must be able to allow movement, for example an opening and closing movement, in relation to the robot in order to adapt to the metal sheets or plates to be assembled, in particular during squeezing which corresponds to the insertion of the two workpieces to be welded one on top of the other between the electrodes of the pliers and to the establishment of a steady force on the two electrodes creating an electric circuit.

When the welding has been performed, the pliers are then opened and brought by the robot to another point for dot welding to be performed.

During these displacements, in particular to position the welding pliers in relation to the metal sheets or plates to be assembled, the movement of the pliers, which are open, may prove to be a problem and prevent a precise trajectory and positioning of the assembly. Specifically, to optimize the cycle times of the robot, the latter always moves along its various axes at its maximum speed. As a result, during accelerations given by the robot, the welding pliers tend to oscillate.

Also, to avoid major inertia phenomena and prevent the pliers from turning due to the accelerations given by the robot, the movement of the whole pliers is momentarily locked by an indexing system. Also, most welding pliers are fitted with an indexing system having an influence on the pliers during their displacement from one work station to another for example.

The electrically driven welding pliers commonly used have an indexing and de-indexing system consisting of a pneumatic cylinder of which the extended rod position is used to immobilize the pliers and of which the retracted rod position releases the movement of said pliers in order to allow self-centering of the electrodes on a metal sheet or plate to be assembled during squeezing and this is achieved without stress on the metal sheets or plates. In order to facilitate self-centering, the pliers comprise balance springs to bring the pliers to a balanced position around their welding plane.

However, in the case of electrically driven welding pliers, the presence of the pneumatic cylinder involves, in addition to the electric circuit for driving the pliers, the presence of a compressed-air circuit as well as all the attendant elements, namely pipework, a compressor, etc.

It is therefore necessary to provide two different types of supply.

These known indexing/de-indexing systems employing a pneumatic cylinder furthermore have the disadvantage of requiring, for their control, a brushless shaft variable-speed drive which greatly increases the cost of the welding pliers.

In addition, the use of pneumatic cylinders and of electric variable-speed drives brings with it high maintenance expenses and sources of failure prejudicial to the efficiency of the welding pliers.

To alleviate these disadvantages, it has been proposed (see WO 99/38640) to replace the pneumatic indexing cylinder with a purely mechanical system controlled by the electrical control means of the pliers. This novel indexing/de-indexing system is however tricky to use and is sensitive to wear.

In consequence, the present invention aims to alleviate these disadvantages by proposing electrically driven welding pliers in which the device for locking and unlocking the movement of the welding pliers in relation to the welding plane no longer requires a pneumatic supply or a mechanical system.

For this purpose, the object of the present invention is electrically driven dot welding pliers of the type comprising an indexed fixed arm and a mobile arm, respectively provided with an electrode, as well as an indexing and de-indexing device locking and unlocking the movement of the pliers in relation to the welding plane and mounted on the support of the pliers, characterized in that said indexing and de-indexing device comprises an electric stepper motor controlling, via a screw/nut-type mechanical transmission, a sliding indexing pin moving between a first position in which the free end of the sliding indexing pin butts against an indexed fixed arm and a second position in which the free end of the indexing pin is spaced apart from the fixed indexed arm, said electric stepper motor being controlled by an electronic management module designed to receive, from a robot rack or a control cabinet or desk, at least one control signal and, in response to the reception of said signal, to power said motor and provide controlled displacement of said indexing pin.

The indexing/de-indexing system according to the invention is therefore purely electrical and is controlled directly by the robot rack or by a control desk. It therefore allows extremely simple guidance, with means of easy maintenance and practically no wear, with a power supply necessarily present on the welding unit and without requiring the use of a variable-speed drive.

In addition, this novel indexing/de-indexing system may have the advantage, according to a preferred embodiment of the invention, of being nonreversible due to the use of a nonreversible screw/nut-type mechanical transmission, such that the position of the indexing pin cannot then be modified mechanically, for example owing to the effect of the inertia of the indexed fixed arm.

The invention will be well understood on subsequent reading of an embodiment, with reference to the appended drawing in which:

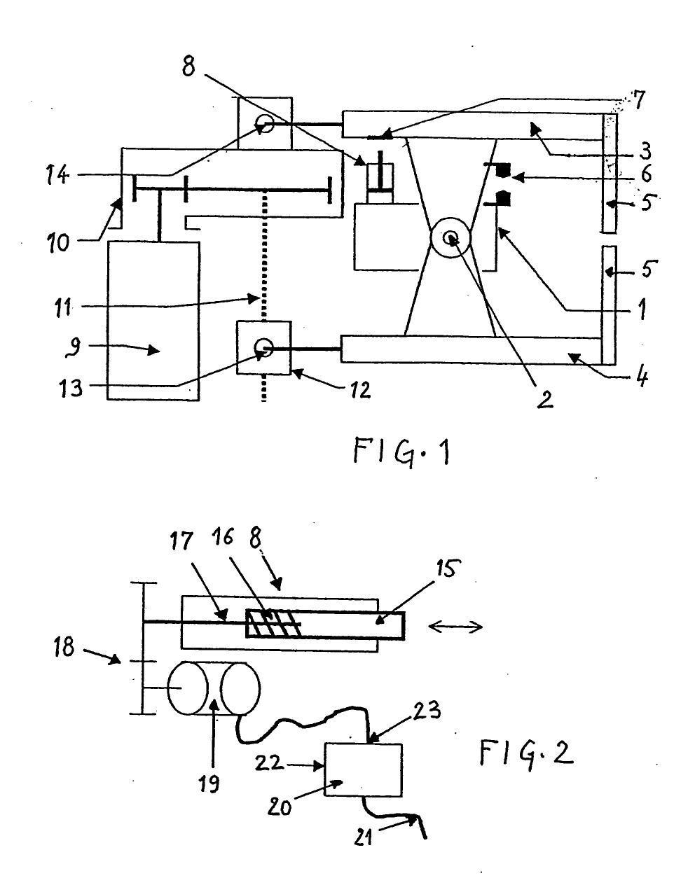

FIG. 1 is a schematic view of welding pliers, of their control means and of their indexing/de-indexing means and

FIG. 2 is a schematic view of the indexing/de-indexing means and of their control units.

Refer first of all to FIG. 1 which represents schematically, as an example, X-shaped dot welding pliers, the invention applying equally to J-shaped or C-shaped welding pliers.

Mounted on a support 1, secured for example to a robot (not shown), is a pivot shaft 2 on which an indexed arm 3 called “fixed” and a mobile arm 4 are articulated, each arm 3, 4 being fitted with a welding electrode 5.

The electrodes 5 are supplied by a source of welding current (not shown).

The relative movement of the arms 3, 4 is limited by stops 6. The indexed arm 3 is fitted with an indexing pin 7 which cooperates with an indexing cylinder 8, intended to immobilize the pliers during their displacements, which cylinder is mounted on the support 1 of the pliers.

The welding pliers comprising the arms 3, 4 are secured to a drive unit comprising an electric motor 8 which drives in rotation, via a reduction gear 10, a screw 11. A nut 12 cooperates with the screw 11 and serves as an anchorage 13 to the mobile arm 4. The indexed arm 3 is connected by an anchorage 14 to the drive unit.

The assembly that has just been described and its operation are well known. During welding, the indexing cylinder 8 being retracted, the pliers are free to rotate about its fixed shaft 2, the movement being limited by the stops 6. During movement of the pliers, irrespective of the relative angular position of the arms 3, 4, actuation of the indexing cylinder 8 immobilizes the arm 3 which becomes fixed, such that the pliers are frozen in position in space.

The indexing cylinder 8 may equally be used to detach the electrode 5, called “fixed electrode”, from the indexed arm 3, when that is necessary.

The present invention relates essentially to the indexing cylinder 8 and will be explained in greater detail with reference to FIG. 2.

According to the invention, the indexing cylinder 8 is an electric cylinder, the push rod or indexing pin 15 of which comprises or is secured to a nut 16 cooperating with a screw 17. The screw 17 is driven in rotation, via a mechanical transmission, produced here in the form of a reduction gear 18, by means of an electric stepper motor 19. In preference, the screw 17/nut 16 assembly is nonreversible.

The motor 19 is controlled by an electronic management module 20 connected to an electric power supply 21. The management module 20 comprises an input 22 receiving control signals and a control output 23 linked to the motor 19.

The control signals applied to the input 22 of the management module 20 originate either from the rack of a robot, or from a control cabinet or desk (not shown). These signals can be either an indexation signal, or a de-indexation signal, or an indexation signal and a de-indexation signal, depending on whether the system controlled is monostable or bistable.

The use of an electric indexing cylinder and its mode of control present great advantages over the conventional use of a pneumatic indexing cylinder.

In the first place, the need for a source of compressed air to supply the indexing cylinder is removed. Similarly, the control of the indexing cylinder no longer requires the use of a shaft variable-speed drive of the brushless type. The assembly is of compact and robust construction and is easy to maintain.

As already indicated, when the screw 17/nut 16 system is nonreversible, indexing is reliably provided without being influenced for example by the inertia of the indexed fixed arm 3. The control of the indexing cylinder is very simple and, furthermore, free from delay.

1. Electrically driven dot welding pliers of the type comprising an indexed fixed arm (3) and a mobile arm (4), respectively provided with an electrode (5), as well as an indexing and de-indexing device (8) locking and unlocking the movement of the pliers in relation to the welding plane and mounted on the support (1) of the pliers, characterized in that said indexing and de-indexing device comprises an electric stepper motor (19) controlling, via a screw/nut-type mechanical transmission (18), a sliding indexing pin (15) moving between a first position in which the free end of the sliding indexing pin (15) butts against an indexed fixed arm (3) and a second position in which the free end of the indexing pin (15) is spaced apart from the fixed indexed arm (3), said electric stepper motor (19) being controlled by an electronic management module (20) designed to receive, from a robot rack or a control cabinet or desk, at least one control signal (22) and, in response to the reception of said signal, to power said motor (19) and provide controlled displacement of said indexing pin (15).

2. The welding pliers as claimed in claim 1, characterized in that the mechanical transmission (18) is nonreversible.

3. The pliers as claimed in claim 1, characterized in that the pliers are of the X-shaped type and comprise two arms (3, 4) mounted so as to pivot about a shaft (2) secured to the support (1) of the pliers.

4. The pliers as claimed in claim 2, characterized in that the pliers are of the X-shaped type and comprise two arms (3, 4) mounted so as to pivot about a shaft (2) secured to the support (1) of the pliers.
